(19) United States
(12) Patent Application Publication
(10) Pub. No.: US 2026/0107223 A1
(43) Pub. Date: Apr. 16, 2026

(54) LOW POWER MODE (LPM) FOR OFFSET ZERO INTERMEDIATE FREQUENCY (OZIF) RECEIVER

(71) Applicant: QUALCOMM Incorporated, San Diego, CA (US)

(72) Inventors: Saranyan NAGARAJAN, HYDERABAD (IN); Srinivas PACHAVA, Hyderabad (IN); Raveesh JUNEJA, Hyderabad (IN); Yung-Yih JIAN, Campbell, CA (US); Parthiban RAJENDRAN, Hyderabad (IN); Ehab ABDEL GHANY, San Diego, CA (US); Mahim RANJAN, San Diego, CA (US)

(21) Appl. No.: 18/912,294

(22) Filed: Oct. 10, 2024

(51) Int. Cl. H04W 52/02; H04L 5/00

(52) U.S. Cl. CPC H04W 52/0212; H04L 5/0098; H04W 52/0238

(57) ABSTRACT

A method for controlling a wireless radio frequency (RF) transceiver includes determining whether a first grant for a primary component carrier (PCC) is below a first threshold and a secondary component carrier (SCC) is deactivated. The method also includes switching the wireless RF transceiver from a high performance mode to a low power mode in response to the first grant being below the first threshold. The method further includes processing an incoming signal in an offset zero intermediate frequency (OZIF) mode of the wireless RF transceiver in accordance with the low power mode.

### FIELD OF THE DISCLOSURE

The present disclosure relates generally to wireless communication and, more specifically, to a low power mode (LPM) for offset zero intermediate frequency (OZIF) receivers.

### BACKGROUND

One goal driving the wireless communication industry is providing consumers with increased bandwidth. The use of carrier aggregation in current generation wireless communication systems provides one possible solution for achieving this goal. Carrier aggregation enables a wireless carrier to increase bandwidth by simultaneously using multiple frequencies for a single communication stream. While carrier aggregation increases an amount of data provided to an end user device, implementing carrier aggregation may be challenging due to an amount of power consumed by the end user device when processing received carrier aggregation signals.

Mobile radio frequency (RF) chip designs (e.g., mobile RF transceivers) have migrated to deep sub-micron process nodes due to cost and power consumption considerations. The design complexity of mobile RF transceivers is further increased by added circuit functions to support communication enhancements. For example, the design complexity of these mobile RF chips is complicated by the need to incorporate circuit functions to support carrier aggregation. Further design challenges for mobile RF transceivers include analog/RF performance considerations, including power consumption and other performance considerations.

In practice, some issues arise with implementing mobile RF transceivers, such as those involving non-contiguous carrier aggregation (NCCA). It is desirable for a wireless device to efficiently support non-contiguous carrier aggregation.

### SUMMARY

In aspects of the present disclosure, a method for controlling a wireless radio frequency (RF) transceiver includes determining whether a first grant for a primary component carrier (PCC) is below a first threshold and a secondary component carrier (SCC) is deactivated. The method also includes switching the wireless RF transceiver from a high performance mode to a low power mode in response to the first grant being below the first threshold. The method further includes processing an incoming signal in an offset zero intermediate frequency (OZIF) mode of the wireless RF transceiver in accordance with the low power mode.

Other aspects of the present disclosure are directed to an apparatus. The apparatus has one or more memories and one or more processors coupled to the one or more memories. The processor(s) is configured to determine whether a first grant for a primary component carrier (PCC) is below a first threshold and a secondary component carrier (SCC) is deactivated. The processor(s) is also configured to switch the wireless RF transceiver from a high performance mode to a low power mode in response to the first grant being below the first threshold. The processor(s) is further configured to process an incoming signal in an offset zero intermediate frequency (OZIF) mode of the wireless RF transceiver in accordance with the low power mode.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1 shows a wireless device communicating with a wireless system.

FIGS. 2A-2D show four examples of carrier aggregation.

FIG. 3 shows a block diagram of the wireless device in FIG. 1.

FIG. 4 illustrates an example of carrier aggregation processing with two local oscillators, in accordance with various aspects of the present disclosure.

FIG. 5 illustrates an example of carrier aggregation processing with a single local oscillator operating in an offset zero intermediate frequency (OZIF) configuration, in accordance with various aspects of the present disclosure.

FIG. 6 is a block diagram illustrating an example of a receiver with two receive chains, in accordance with various aspects of the present disclosure.

FIG. 7 is a diagram illustrating an example of power mode switching while processing two active non-contiguous component carriers with an offset zero intermediate frequency (OZIF) receiver, in accordance with various aspects of the present disclosure.

FIG. 8 is a diagram illustrating an example of power mode switching while processing one active component carrier with an offset zero intermediate frequency (OZIF) receiver, in accordance with various aspects of the present disclosure.

FIG. 9 is a flow diagram illustrating an example of a method of power mode switching when processing a non-contiguous carrier aggregation (NCCA) signal in an offset zero intermediate frequency (OZIF) receiver, in accordance with various aspects of the present disclosure.

FIG. 10 is a block diagram showing an exemplary wireless communication system in which an aspect of the present disclosure may be advantageously employed.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent, however, to those skilled in the art that these concepts may be practiced without these specific details. In some instances, well-known structures and components are shown in block diagram form in order to avoid obscuring such concepts. Other aspects, as well as features and advantages of various aspects, will become apparent to those of skill in the art through consideration of the ensuing description, the accompanying drawings, and the appended claims.

As described herein, the use of the term “and/or” is intended to represent an “inclusive OR,” and the use of the term “or” is intended to represent an “exclusive OR.” As described herein, the term “exemplary” used throughout this description means “serving as an example, instance, or illustration,” and should not necessarily be construed as preferred or advantageous over other exemplary configurations. The term “coupled” used throughout this description means “connected, whether directly or indirectly through intervening connections (e.g., a switch), electrical, mechanical, or otherwise,” and is not necessarily limited to physical connections. Additionally, the connections can be such that the objects are permanently connected or releasably connected. The connections can be through switches.

Advances in technology result in smaller and more powerful computing devices. For example, a variety of portable personal computing devices currently exist, including wireless computing devices, such as portable wireless telephones, user equipment (UEs), personal digital assistants (PDAs), and paging devices that are small, lightweight, and easily carried by users. More specifically, portable wireless telephones, such as cellular telephones and Internet protocol (IP) telephones, can communicate voice and data packets over wireless networks.

One goal driving the wireless communication industry is providing consumers with increased bandwidth. The use of carrier aggregation in current generation wireless communication systems provides one possible solution for achieving this goal. Carrier aggregation enables a wireless carrier to increase bandwidth by simultaneously using multiple frequencies for a single communication stream. While carrier aggregation may increase an amount of data provided to an end user device (e.g., wireless device), implementing carrier aggregation may be challenging due to an increase in power consumption at the end user device when processing the carrier frequencies used for data transmissions.

A wireless device (e.g., a cellular phone or a smartphone) in a wireless communication system may transmit and receive data using two-way communication. The wireless device may include a transmitter for transmitting data and a receiver for receiving data. For data transmission, the transmitter may modulate a radio frequency (RF) carrier signal with data to obtain a modulated RF signal, amplify the modulated RF signal to obtain an amplified RF signal having the proper output power level, and transmit the amplified RF signal via an antenna to a base station. For data reception, the receiver may obtain a received RF signal (via the antenna) and may amplify and process the received RF signal to recover data sent by the base station.

A wireless device may support carrier aggregation, which enables simultaneous operation on multiple carriers. A carrier may refer to a range of frequencies used for communication and may be associated with certain characteristics. For example, a carrier may be associated with system information describing operation on the carrier. A carrier may also be referred to as a component carrier (CC), a frequency channel, and/or a cell. It is desirable for a wireless device to efficiently support carrier aggregation.

In general, carrier aggregation (CA) may be categorized into intra-band CA and inter-band CA. Intra-band CA refers to operation on multiple carriers within the same band, and inter-band CA refers to operation on multiple carriers in different bands. The carriers may be contiguous or non-contiguous. Non-contiguous carrier aggregation has unique issues due to the separation of frequency bands.

Some non-contiguous CA (NCCA) architectures have two local oscillators (LOs). Other architectures have a single LO operating in an offset zero intermediate frequency (OZIF) mode. A zero intermediate frequency (ZIF) receiver converts a received radio frequency (RF) signal directly into a baseband signal without any intermediate frequency (IF) stages. By using ZIF conversion, the radio/analog front end is simplified, resulting in low power consumption, a small size, and high reliability. An offset ZIF receiver uses an offset frequency in between carrier frequencies in a non-contiguous carrier aggregation signal.

Aspects of the present disclosure provide techniques for operating in a low power mode when processing non-contiguous carrier aggregation signals with an offset zero intermediate frequency (OZIF) receiver. In OZIF low power mode, the receiver switches from a high performance mode synthesizer to low power mode synthesizer. A controller (e.g., a software controller) can switch from the high performance mode synthesizer to the low power mode synthesizer when resource grants for the primary component carrier (PCC) and/or secondary component carrier (SCC) are low. Advantages include significant power savings when processing two configured non-contiguous component carriers with an OZIF receiver.

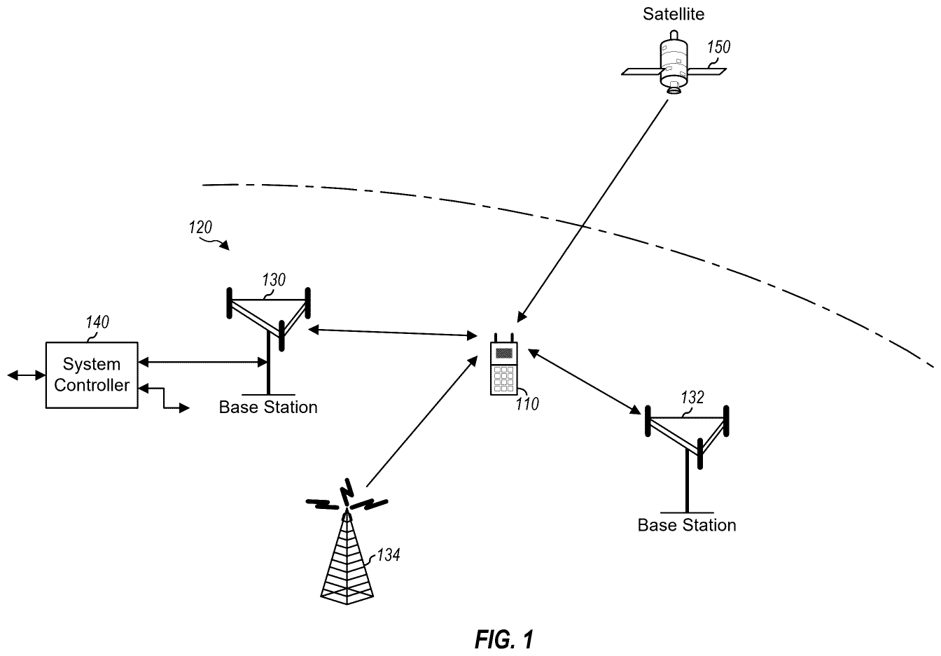

FIG. 1 shows a wireless device 110 communicating with a wireless system 120. The wireless device includes the described OZIF receiver. The wireless system 120 may be a 5G, long term evolution (LTE) system, a code division multiple access (CDMA) system, a global system for mobile communications (GSM) system, a wireless local area network (WLAN) system, or some other wireless system. A CDMA system may implement wideband CDMA (WCDMA), time division synchronous CDMA (TD-SCDMA), CDMA2000, or some other version of CDMA. For simplicity, FIG. 1 shows the wireless system 120 including two base stations 130 and 132 and one system controller 140. In general, a wireless system may include any number of base stations and any number of network entities.

A wireless device 110 may also be referred to as a user equipment (UE), a mobile station, a terminal, an access terminal, a subscriber unit, a station, etc. The wireless device 110 may be a cellular phone, a smartphone, a tablet, a wireless modem, a personal digital assistant (PDA), a handheld device, a laptop computer, a Smartbook, a netbook, a cordless phone, a wireless local loop (WLL) station, a Bluetooth device, etc. The wireless device 110 may be capable of communicating with the wireless system 120. The wireless device 110 may also be capable of receiving signals from broadcast stations (e.g., a broadcast station 134), signals from satellites (e.g., a satellite 150) in one or more global navigation satellite systems (GNSS), etc. The wireless device 110 may support one or more radio technologies for wireless communication such as 5G, LTE, CDMA2000, WCDMA, TD-SCDMA, GSM, 802.11, etc.

The wireless device 110 may support carrier aggregation, which is operation on multiple carriers. Carrier aggregation may also be referred to as multi-carrier operation. The wireless device 110 may be able to operate in low-band from 698 to 960 megahertz (MHz), mid-band from 1475 to 2170 MHz, and/or high-band from 2300 to 2690, ultra-high band from 3400 to 3800 MHz, and long-term evolution (LTE) in LTE unlicensed bands (LTE-U/LAA) from 5150 MHz to 5950 MHz. Low-band, mid-band, high-band, ultra-high band, and LTE-U refer to five groups of bands (or band groups), with each band group including a number of frequency bands (or simply, “bands”). For example, in some systems each band may cover up to 200 MHz and may include one or more carriers. For example, each carrier may cover up to 40 MHz in LTE. Of course, the range for each of the bands is merely exemplary and not limiting, and other frequency ranges may be used.

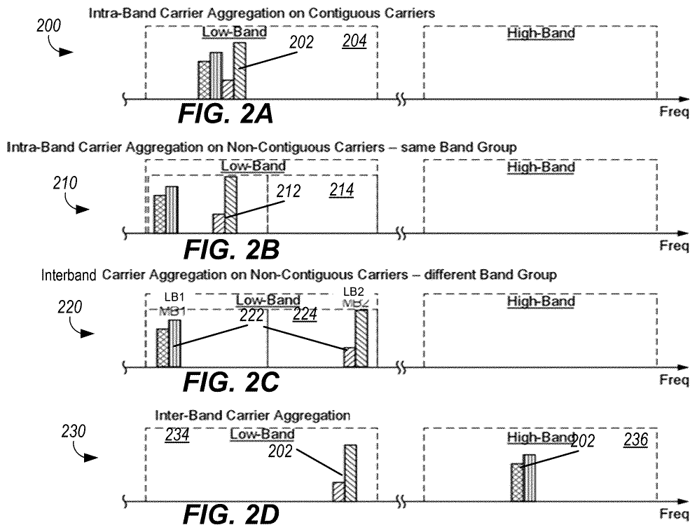

FIG. 2A shows an example of contiguous intra-band CA 200. In the example shown in FIG. 2A, a wireless device (e.g., the wireless device 110) is configured with four contiguous carriers 202 in the same band, which is within a low-band 204. The wireless device may send and/or receive transmissions on multiple contiguous carriers within the same band.

FIG. 2B shows an example of non-contiguous intra-band CA 210. In the example shown in FIG. 2B, a wireless device (e.g., the wireless device 110) is configured with four non-contiguous carriers 212 in the same band, within a low-band 214. The carriers may be separated by 5 MHz, 10 MHz, or some other amount. The wireless device may send and/or receive transmissions on multiple non-contiguous carriers within the same band.

FIG. 2C shows an example of inter-band CA in different band groups 220. In the example shown in FIG. 2C, a wireless device (e.g., the wireless device 110) is configured with four carriers 222 in two bands within the same band group, which is a low-band 224. The wireless device may send and/or receive transmissions on multiple carriers in different bands in the same band group (e.g., low-band 1 (LB1) and low-band 2 (LB2) in FIG. 2C).

FIG. 2D shows an example of inter-band CA in different band groups 230. In the example shown in FIG. 2D, a wireless device (e.g., the wireless device 110) is configured with four carriers 232 in two bands in different band groups, which include two carriers in one band within a low-band 234 and two additional carriers in another band within a high-band 236. The wireless device may send and/or receive transmissions on multiple carriers in different bands in different band groups (e.g., low-band and high-band in FIG. 2D).

FIGS. 2A to 2D show four examples of carrier aggregation. Carrier aggregation may also be supported for other combinations of bands and band groups. For example, carrier aggregation may be supported for a low-band and a high-band, a mid-band and a high-band, and a high-band and a high-band.

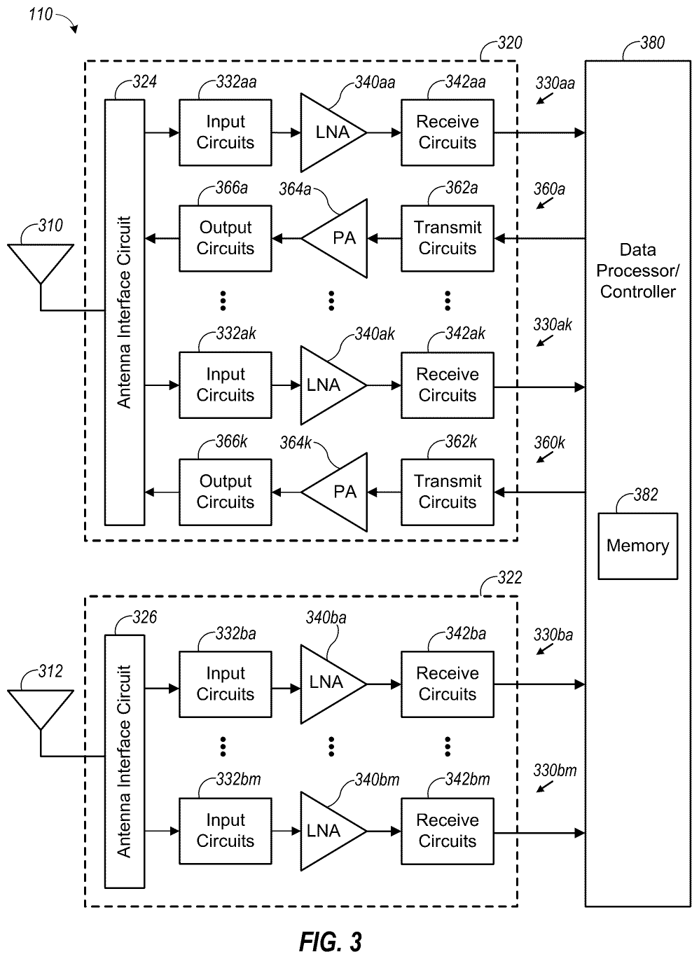

FIG. 3 shows a block diagram of an exemplary design of the wireless device 110 in FIG. 1. In this exemplary design, the wireless device 110 includes a transceiver 320 coupled to an antenna 310 (e.g., a primary antenna), a receiver 322 coupled to a secondary antenna 312, and a data processor/controller 380. The transceiver 320 includes multiple (K) receivers (e.g., 330aa to 330ak) and multiple (K) transmitters (e.g., 360a to 360k) for supporting multiple bands, carrier aggregation, as well as multiple radio technologies. The receiver 322 include multiple (M) receivers 330ba to 330bm for supporting multiple bands, carrier aggregation, multiple radio technologies, receive diversity, and multiple-input and multiple-output (MIMO) transmission from multiple transmit antennas to multiple receive antennas, etc.

In the exemplary design shown in FIG. 3, each of the receivers 330 includes input circuits 332, a low-noise amplifier (LNA) 340, and receive circuits 342. For data reception, the antenna 310 receives signals from base stations and/or other transmitter stations and provides a received radio frequency (RF) signal, which is routed through an antenna interface circuit 324 and provided to a selected receiver. The antenna interface circuit 324 may include switches, duplexers, transmit filters, receive filters, and the like. The description below assumes that the receiver 330aa is the selected receiver. Within the receiver 330aa, the received RF signal is passed through input circuits 332aa, which provide an input RF signal to an LNA 340aa. The input circuits 332aa may include a matching circuit, a receive filter, and the like. The LNA 340aa amplifies the input RF signal and provides an output RF signal. The receive circuits 342aa amplify, filter, and downconvert the output RF signal from RF to baseband and provide an analog input signal to a data processor/controller 380. The receive circuits 342aa may include mixers, filters, amplifiers, matching circuits, an oscillator, a local oscillator (LO) generator, a phase locked loop (PLL), and the like. Each remaining one of the receivers 330 in the transceiver 320 and each of the receivers 330 in the receiver 322 may operate in a similar manner as the receiver 330aa in the transceiver 320.

In the exemplary design shown in FIG. 3, each of the transmitters 360 includes transmit circuits 362, a power amplifier (PA) 364, and output circuits 366. For data transmission, the data processor/controller 380 processes (e.g., encodes and modulates) data to be transmitted and provides an analog output signal to a selected transmitter. The description below assumes that transmitter 360a is the selected transmitter. Within the transmitter 360a, the transmit circuits 362a amplify, filter, and upconvert the analog output signal from baseband to RF for providing a modulated RF signal. The transmit circuits 362a may include amplifiers, filters, mixers, matching circuits, an oscillator, an LO generator, a PLL, and the like. A PA 364a receives and amplifies the modulated RF signal and provides a transmit RF signal having the proper output power level. The transmit RF signal is passed through output circuits 366a, routed through the antenna interface circuit 324, and transmitted via the antenna 310. The output circuits 366a may include a matching circuit, a transmit filter, a directional coupler, and the like.

FIG. 3 shows an exemplary design of the receivers 330 and the transmitters 360. A receiver and a transmitter may also include other circuits not shown in FIG. 3, such as filters, matching circuits, etc. All or a portion of the transceiver 320 and the receiver 322 may be implemented on one or more analog integrated circuits (ICs), RF ICs (RFICs), mixed-signal ICs, or other like analog circuits. For example, LNAs 340, receive circuits 342, and transmit circuits 362 may be implemented on one module, which may be an RFIC. Antenna interface circuits (e.g., 324 and 326), the input circuits 332, the output circuits 366, and the PAs 364 may be implemented on another module, which may be a hybrid module. The circuits in the transceiver 320 and the receiver 322 may also be implemented in other configurations.

The data processor/controller 380 may perform various functions for the wireless device 110. For example, the data processor/controller 380 may perform processing for data received via the receivers 330 and data being transmitted via the transmitters 360. The data processor/controller 380 may control the operation of antenna interface circuits (e.g., 324 and 326), input circuits 332, LNAs 340, receive circuits 342, transmit circuits 362, PAs 364, output circuits 366, or a combination thereof. A memory 382 may store program codes and data for the data processor/controller 380. The data processor/controller 380 may be implemented on one or more application specific integrated circuits (ASICs) and/or other ICs.

The wireless device 110 may receive transmissions from one or more base stations/cells on multiple carriers at different frequencies for CA. For example, the wireless device 110 may include a non-contiguous CA architecture with phase locked loops (PLLs) and local oscillators (LOs).

One goal driving the wireless communication industry is providing consumers with increased bandwidth. Carrier aggregation enables a wireless carrier to increase bandwidth by simultaneously using multiple frequencies for a single communication stream. Therefore, carrier aggregation is an example of a solution for increasing bandwidth. As discussed, implementing carrier aggregation may be complicated by the amount of power consumed by an end user device when processing received carrier aggregation signals.

In general, carrier aggregation (CA) may be categorized into intra-band CA and inter-band CA. Intra-band CA refers to operation on multiple carriers within the same band, and inter-band CA refers to operation on multiple carriers in different bands. The carriers may be contiguous or non-contiguous. Non-contiguous carrier aggregation has unique issues due to the separation of frequency bands.

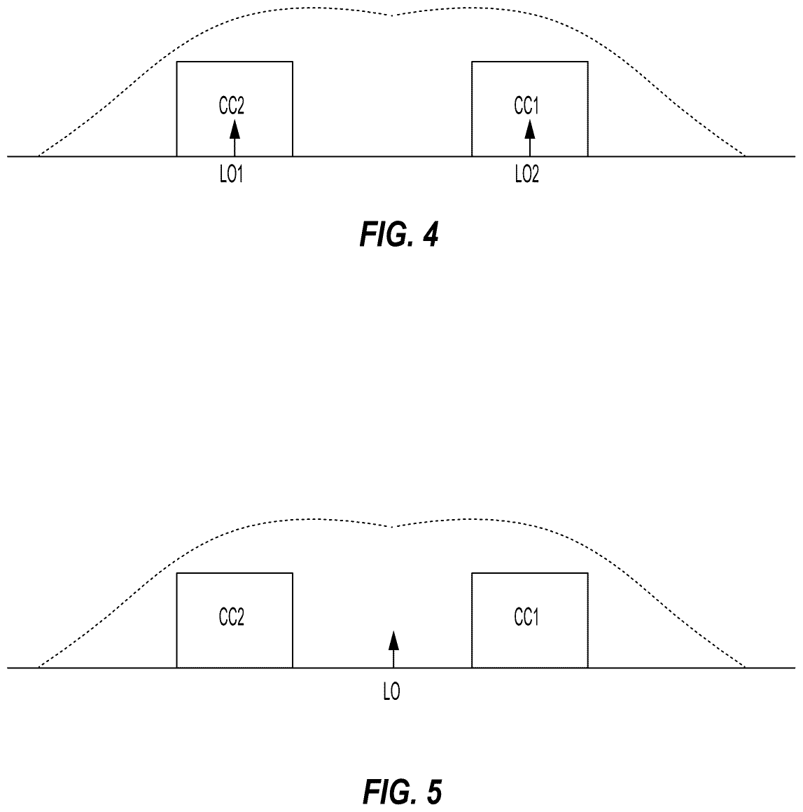

Some non-contiguous CA (NCCA) architectures have two local oscillators (LOs). FIG. 4 illustrates an example of carrier aggregation processing with two local oscillators, in accordance with various aspects of the present disclosure. As seen in FIG. 4, non-contiguous carrier aggregation reception may be implemented using two downlink paths in a radio frequency (RF) receiver. The incoming signal enters an RF receiver and splits into two signals after processing by a low noise amplifier (LNA) (not shown in the example of FIG. 4). A primary component carrier (PCC) (shown as CC2) is down-converted by a first local oscillator (LO) (LO1) in a first downlink path. A secondary component carrier (SCC) (shown as CC1) is down-converted using a second LO (LO2) in a second downlink path.

Single LO architectures are simpler than two LOs but may consume higher power when always operating in a high performance mode. A single LO architecture may include an offset zero intermediate frequency (OZIF) receiver.

FIG. 5 illustrates an example of carrier aggregation processing with a single local oscillator operating in an offset zero intermediate frequency (OZIF) configuration, in accordance with various aspects of the present disclosure. In the example of FIG. 5, a downlink path limited transceiver implements non-contiguous carrier aggregation reception using a single downlink path. A single local oscillator (LO) tunes to the middle of a PCC (shown as CC2) and a SCC (shown as CC1), and the signal is down-converted based on an OZIF methodology. A zero intermediate frequency (ZIF) receiver converts a received radio frequency (RF) signal directly into a baseband signal without any intermediate frequency (IF) stages. The ZIF is offset because the center frequency is offset from the PCC (CC2) and the SCC (CC1).

When an RF transceiver operates in OZIF mode, there is an opportunity to save power by entering a low power mode (LPM) depending on the grants for the PCC and SCC. Techniques for determining when to enter low power mode during OZIF processing are desired.

In OZIF LPM mode, the receiver switches from a high performance mode synthesizer (HPM Synth) to a low power mode synthesizer (LPM Synth). For example, a high performance mode synthesizer may use an LC (inductor/capacitor) oscillator, whereas a low power mode synthesizer may employ a ring oscillator. Low power mode, however, is only currently available for single component carrier cases.

Aspects of the present disclosure introduce a controller (e.g., a software controller) that can switch from a high performance mode synthesizer to a low power mode synthesizer when resource grants for the PCC and SCC are low. For example, resource grants may be considered low when a carrier is configured with a modulation and coding scheme (MCS) below an MCS threshold, or when a carrier receives control channel traffic only (e.g., no data channel traffic).

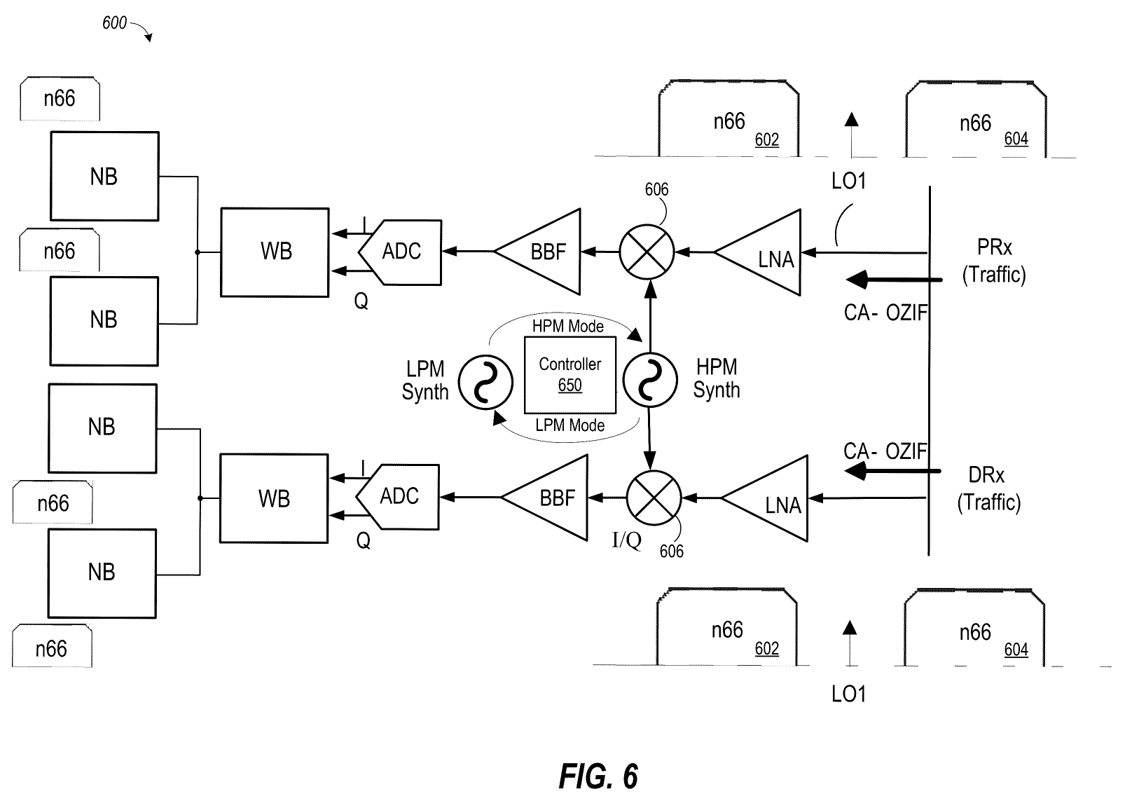

FIG. 6 is a block diagram illustrating an example of a receiver 600 with two receive chains, in accordance with various aspects of the present disclosure. The receiver 600 includes a primary receive chain PRx and a diversity receive chain DRx. Each receive chain PRx, DRx includes a local oscillator (shown as LO1), for example, operating with a center frequency of 2.150 GHz for receiving a signal with two non-contiguous carriers 602, 604. Each non-contiguous carrier is received in a frequency space designated as n66. The receiver 600 operates in a carrier aggregation (CA)-OZIF mode. Each receive chain PRx, DRx includes a low noise amplifier (LNA) that forwards the received signal to a mixer 606. The mixer 606 mixes the received signal with an output of either a high performance mode synthesizer (shown as HPM Synth) or a low power mode synthesizer (shown as LPM Synth). A controller 650 determines which synthesizer to select, as will be described in more detail below.

In each receive chain PRx, DRx, a baseband filter (BBF) filters the mixed signal to generate a filtered signal for an analog-to-digital converter (ADC). The ADC generates I and Q samples, which correspond to a wideband (WB) signal. Each component carrier of a WB signal is then processed as a narrowband (NB) component within the receive chains PRx, DRx.

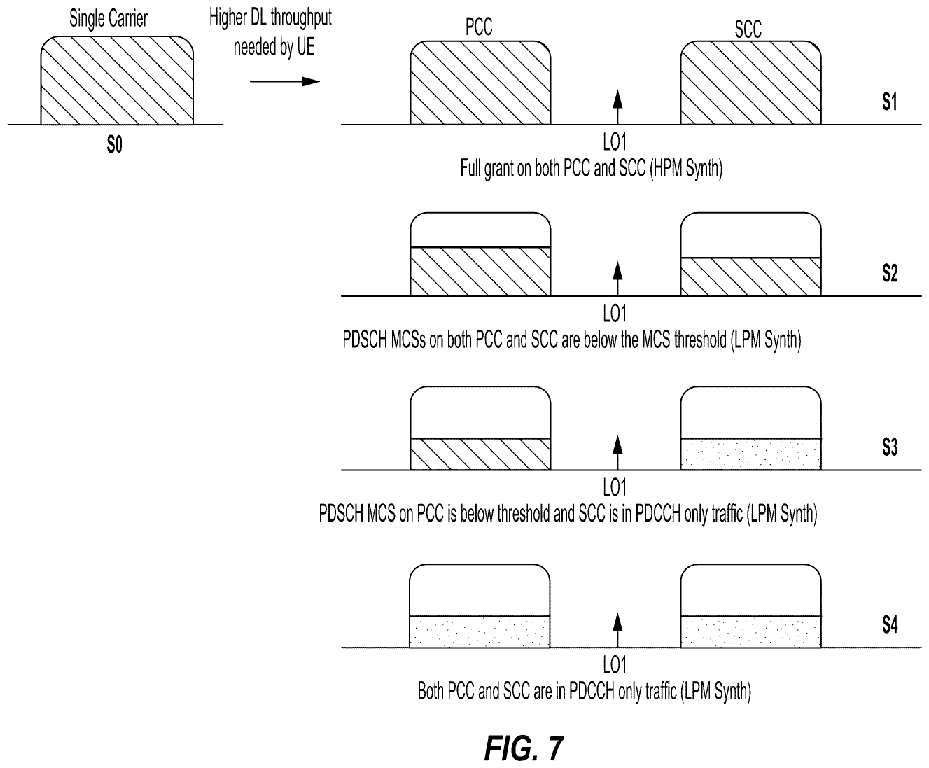

Aspects of the present disclosure relate to how a controller performs power mode switching with two active component carriers (CCs). FIG. 7 is a diagram illustrating an example of power mode switching while processing two active non-contiguous component carriers with an offset zero intermediate frequency (OZIF) receiver, in accordance with various aspects of the present disclosure. In the example of FIG. 7, at state S0, the UE is in single carrier mode, and thus only a single component carrier is active. At state S1, the network activates a secondary component carrier (SCC). The UE receives a full grant for both a primary component carrier (PCC) and the secondary component carrier (SCC). Thus, the controller enables the high performance mode synthesizer (HPM Synth).

At state S2, the modulation and coding scheme (MCS) of both the primary component carrier (PCC) and the secondary component carrier (SCC) for data (e.g., the physical downlink shared channel (PDSCH)) are below an MCS threshold. Accordingly, the software controller enables the low power mode synthesizer (LPM Synth). For example, as seen in the example Table 1 below, an MCS threshold may be MCS1 for a rank indicator of X with 256 quadrature amplitude modulation (QAM), such that if the configured MCS index is less than or equal to MCS 1, the software controller triggers entry into the low power mode. On the other hand, an MCS threshold may be MCS 2 for a rank indicator of X with 256 quadrature amplitude modulation (QAM), such that if the configured MCS index is MCS 2 or greater, the software controller triggers exit from the low power mode. The operating frequency band may impact the values of the MCS threshold. For example, the MCS threshold may switch if the UE operates in a different band. Similarly, the modulation scheme also impacts the threshold values. For example, if 64 QAM is used instead of 256 QAM, the thresholds may change from MCS 1 to MCS 3 for low power mode entry, and from MCS 2 to MCS 4 for low power mode exit. Finally, the rank indicator may also affect the MCS threshold value. For example, a higher rank indicator may increase the MCS threshold value for entering and exiting the low power mode.

TABLE 1

| | LPM Enter | LPM Exit |
|---|---|---|
| Band Z | RI = X | RI = X |
| 256 QAM | MCS 1 | MCS 2 |
| 64 QAM | MCS 3 | MCS 4 |

At state S3, the PDSCH MCS is below the MCS threshold and the secondary component carrier is only configured for control channel traffic (e.g., the physical downlink control channel (PDCCH)). In this scenario, the software controller enables the low power mode synthesizer (LPM Synth). At state S4, both the primary component carrier (PCC) and the secondary component carrier (SCC) are configured to carry only control channel traffic (e.g., the PDCCH). In this scenario, the software controller enables the low power mode synthesizer (LPM Synth).

Additional conditions for switching to OZIF low power mode are now described. A signal-to-noise ratio (SNR) observed at the baseband modem should be above an SNR threshold for PDCCH decoding on both component carriers. The SNR threshold ensures successful PDCCH decoding. The threshold is a function of the PDCCH code rate: the higher the PDCCH code rate, the higher the SNR threshold. When both CCs are active, the SNR threshold on each CC can be different because a different PDCCH code rate can be scheduled on each CC. Thus, the LPM synthesizer can be enabled only when the SNR with the LPM synthesizer on each CC is higher than the corresponding SNR threshold. When only the PCC is active, only the PCC SNR threshold is considered. Accordingly, depending on the PDCCH code rate the SNR threshold can be different for the PCC and the SCC.

Other conditions for switching include the receiver reciprocal mixing noise should impact the SNR on both component carriers by less than a predefined quantity of decibels (dB). Similarly, transmitter reciprocal mixing noise should impact the SNR on both component carriers by less than a predefined quantity of decibels. A jammer should not be detected. Yet another condition is that a received signal strength indicator (RSSI) of both component carriers should be above a reference sensitivity defined in the 3GPP standards, plus a predetermined quantity (e.g., X dB).

Also, one of the following traffic conditions should be satisfied along with all the other conditions stated above: a moving average of physical downlink shared channel (PDSCH) modulation and coding schemes (MCSs) on both the primary component carrier (PCC) and secondary component carrier (SCC) are below the MCS threshold; a moving average of the PDSCH MCS on the PCC is below the MCS threshold and the SCC is only configured for physical downlink control channel (PDCCH) traffic; or both the PCC and the SCC carry only PDCCH traffic. If any of the above conditions are not satisfied, the software controller switches the UE into the high performance mode.

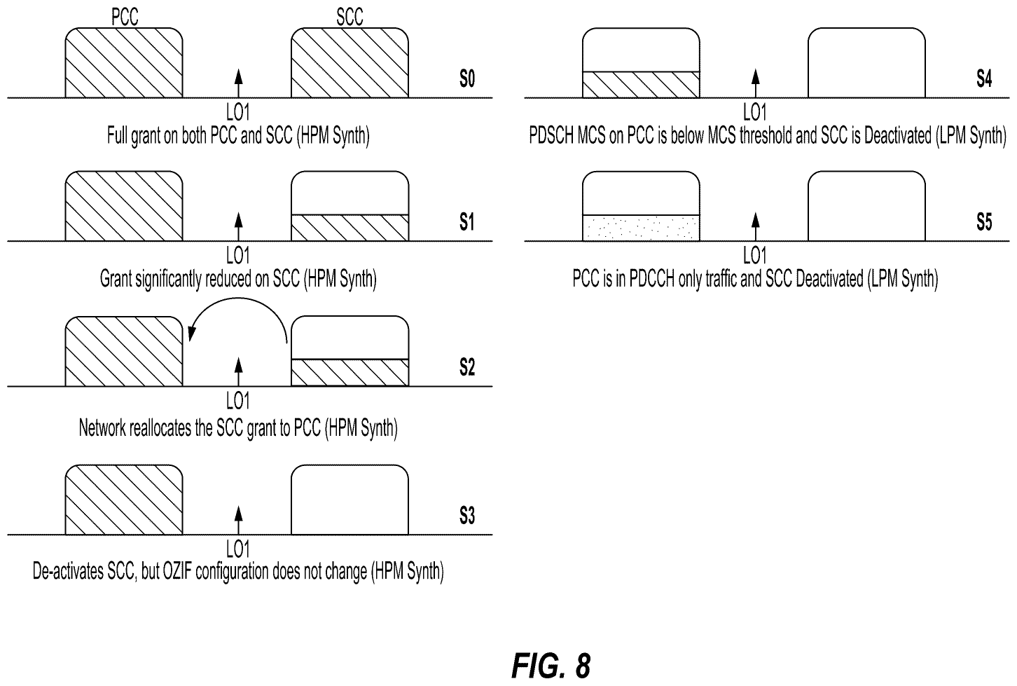

Aspects of the present disclosure also relate to how a software controller performs power mode switching with one active component carrier (CC). FIG. 8 is a diagram illustrating an example of power mode switching while processing one active component carrier with an offset zero intermediate frequency (OZIF) receiver, in accordance with various aspects of the present disclosure. In the example of FIG. 8, at state S0, the UE has received a full grant for both the PCC and the SCC, and thus operates with the high performance mode synthesizer. At state S1, the grant for the SCC significantly reduces, but the UE operation continues with the high performance mode synthesizer. At state S2, the network reallocates the SCC grant to the PCC and the UE remains in the high performance mode. At state S3, the network deactivates the SCC. The UE, however, remains in the OZIF configuration and operates in the high performance mode.

At state S4, the PDSCH MCS is below the MCS threshold and the SCC is deactivated. Thus, the software controller switches the UE into low power mode. At state S5, the PCC carries only PDCCH traffic and the SCC is deactivated. Thus, the software controller switches the UE into low power mode.

Additional conditions for switching to OZIF low power mode are now described with respect to a single active component carrier. A signal-to-noise ratio (SNR) observed at the baseband modem should be above an SNR threshold for physical downlink control channel (PDCCH) decoding on the primary component carrier. Receiver reciprocal mixing noise should impact the SNR on the primary component carrier by less than a predefined quantity of decibels. Transmitter reciprocal mixing noise should impact the SNR on the primary component carrier by less than a predefined quantity of decibels. A jammer should not be detected. A received signal strength indicator (RSSI) of the primary component carrier should be above a reference sensitivity defined in the 3GPP standards, plus a predetermined quantity (e.g., X dB). Additionally, one of the following traffic conditions should be satisfied: a moving average of physical downlink shared channel (PDSCH) modulation and coding schemes (MCSs) on the primary component carrier is below the MCS threshold; or the primary component carrier is only configured for PDCCH traffic. If any of the above conditions are not satisfied, the software controller switches the UE into high performance mode.

Aspects of the present disclosure opportunistically switch to a low power mode synthesizer to save power for non-contiguous carrier aggregation support within a downlink path, while operating in OZIF mode.

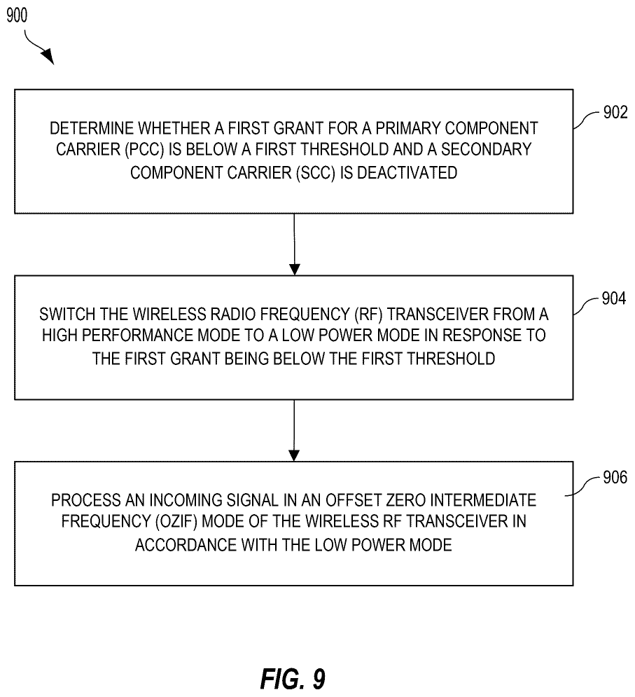

FIG. 9 is a flow diagram illustrating an example of a process 900 of power mode switching when processing a non-contiguous carrier aggregation (NCA) signal in an offset zero intermediate frequency (OZIF) receiver, in accordance with various aspects of the present disclosure. The process 900 is an example of a low power mode (LPM) for offset zero intermediate frequency (OZIF) receivers. As shown in FIG. 9, in some aspects, the process 900 may include determining whether a first grant for a primary component carrier (PCC) is below a first threshold and a secondary component carrier (SCC) is deactivated (block 902). For example, the first grant may be below the first threshold when a first modulation and coding scheme (MCS) for the PCC is less than a first MCS level and/or when the PCC is configured for carrying only physical downlink shared channel (PDSCH) traffic.

In some aspects, the process 900 may include switching the wireless RF transceiver from a high performance mode to a low power mode in response to the first grant being below the first threshold (block 904). In some aspects, the process 900 may include processing an incoming signal in an offset zero intermediate frequency (OZIF) mode of the wireless RF transceiver in accordance with the low power mode (block 906). For example, the wireless RF transceiver may processes the incoming signal with a low power mode synthesizer in accordance with the low power mode.

According to aspects of the present disclosure, a software controller is described. The software controller includes means for determining, means for switching, and means for processing, and may include any of the components shown in FIGS. 3 and 6. In another aspect, the aforementioned means may be any module or any apparatus configured to perform the functions recited by the aforementioned means.

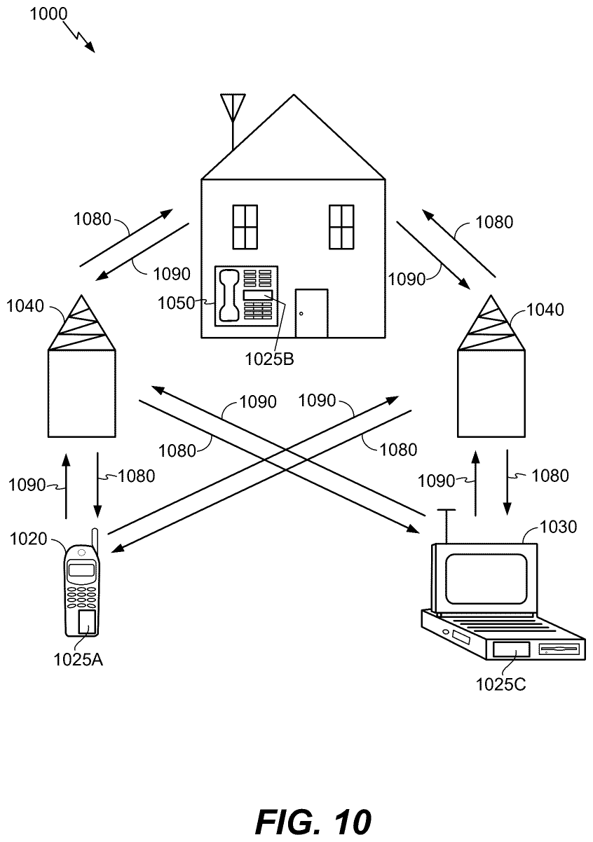

FIG. 10 is a block diagram showing an exemplary wireless communication system 1000 in which aspects of the disclosure may be advantageously employed. For purposes of illustration, FIG. 10 shows three remote units 1020, 1030, and 1050 and two base stations 1040. It will be recognized that wireless communication systems may have many more remote units and base stations. Remote units 1020, 1030, and 1050 include IC devices 1025A, 1025C, and 1025B that include the disclosed filter circuit. It will be recognized that other devices may also include the disclosed filter circuit, such as the base stations, user equipment, and network equipment. FIG. 10 shows forward link signals 1080 from the base station 1040 to the remote units 1020, 1030, and 1050 and reverse link signals 1090 from the remote units 1020, 1030, and 1050 to base station 1040.

In FIG. 10, remote unit 1020 is shown as a mobile telephone, remote unit 1030 is shown as a portable computer, and remote unit 1050 is shown as a fixed location remote unit in a wireless local loop system. For example, a remote units may be a mobile phone, a handheld personal communication systems (PCS) unit, a portable data unit such as a personal digital assistant (PDA), a GPS enabled device, a navigation device, a set top box, a music player, a video player, an entertainment unit, a fixed location data unit such as a meter reading equipment, or other communications device that stores or retrieve data or computer instructions, or combinations thereof. Although FIG. 10 illustrates remote units, the disclosure is not limited to these exemplary illustrated units. Aspects of the disclosure may be suitably employed in many devices, which include the disclosed filter circuit.

### EXAMPLE ASPECTS

Aspect 1: A method of controlling a wireless radio frequency (RF) transceiver, comprising: determining whether a first grant for a primary component carrier (PCC) is below a first threshold and a secondary component carrier (SCC) is deactivated; switching the wireless RF transceiver from a high performance mode to a low power mode in response to the first grant being below the first threshold; and processing an incoming signal in an offset zero intermediate frequency (OZIF) mode of the wireless RF transceiver in accordance with the low power mode.

Aspect 2: The method of Aspect 1, in which the first grant is below the first threshold when a first modulation and coding scheme (MCS) for the PCC is less than a first MCS level.

Aspect 3: The method of Aspect 1 or 2, in which the first grant is below the first threshold when the PCC is configured for carrying only physical downlink shared channel (PDSCH) traffic.

Aspect 4: The method of any of the preceding Aspects further comprising switching the wireless RF transceiver from the high performance mode to the low power mode in response to: a signal to noise ratio (SNR) with a low power mode (LPM) synthesizer exceeding an SNR threshold for physical downlink control channel (PDCCH) decoding on the PCC, receiver reciprocal mixing noise impacting the PCC by less than a receiver threshold, transmitter reciprocal mixing noise impacting the PCC by less than a transmitter threshold, a jamming signal not being detected, and a PCC received signal strength indicator (RSSI) exceeding a reference sensitivity by a predetermined quantity.

Aspect 5: The method of any of the preceding Aspects, in which the wireless RF transceiver processes the incoming signal with a low power mode synthesizer in accordance with the low power mode.

Aspect 6: The method of any of the preceding Aspects, in which a first signal to noise ratio (SNR) is above a first SNR threshold when the PCC is configured for carrying physical downlink control channel (PDCCH) only traffic.

Aspect 7: The method of any of the preceding Aspects, further comprising: determining whether a second grant for a secondary component carrier (SCC) is below a second threshold; and switching the transceiver from the high performance mode to the low power mode in response to the first grant being below the first threshold and the second grant being below the second threshold.

Aspect 8: The method of any of the preceding Aspects, in which the first grant is below the first threshold when a first modulation and coding scheme (MCS) for the PCC is less than a first MCS level, and the second grant is below the second threshold when a second MCS for the SCC is less than a second MCS level.

Aspect 9: The method of any of the preceding Aspects, in which the first grant is below the first threshold when a first modulation and coding scheme (MCS) for the PCC is less than a first MCS level, and a second signal to noise ratio (SNR) is above the second threshold when the SCC is configured for carrying only physical downlink control channel (PDCCH) traffic.

Aspect 10: The method of any of the preceding Aspects, in which the first grant is below the first threshold when the PCC is configured for carrying only physical downlink shared channel (PDSCH) traffic, and the second grant is below the second threshold when the SCC is configured for carrying only PDSCH traffic.

Aspect 11: The method of any of the preceding Aspects, in which a first signal to noise ratio (SNR) is above a first SNR threshold when the PCC is configured for carrying only physical downlink control channel (PDCCH) traffic, and a second SNR is above a second SNR threshold when the SCC is configured for carrying only PDCCH traffic.

Aspect 12: The method of any of the preceding Aspects further comprising switching the wireless RF transceiver from the high performance mode to the low power mode in response to: a PCC signal to noise ratio (SNR) with a low power mode (LPM) synthesizer exceeding an SNR threshold for physical downlink control channel (PDCCH) decoding on the PCC, an SCC SNR with the LPM synthesizer exceeding the SNR threshold for PDCCH decoding on the SCC, receiver reciprocal mixing noise impacting the PCC and impacting the SCC by less than a receiver threshold, transmitter reciprocal mixing noise impacting the PCC and impacting the SCC by less than a transmitter threshold, a jamming signal not being detected, a PCC received signal strength indicator (RSSI) exceeding a reference sensitivity by a predetermined quantity, and an SCC RSSI exceeding the reference sensitivity by the predetermined quantity.

Aspect 13: An apparatus for controlling a wireless radio frequency (RF) transceiver, comprising: at least one memory; and at least one processor coupled to the at least one memory, the at least one processor configured: to determine whether a first grant for a primary component carrier (PCC) is below a first threshold and a secondary carrier component (SCC) is deactivated; to switch the wireless RF transceiver from a high performance mode to a low power mode in response to the first grant being below the first threshold; and to process an incoming signal in an offset zero intermediate frequency (OZIF) mode of the wireless RF transceiver in accordance with the low power mode.

Aspect 14: The apparatus of Aspect 13, in which the first grant is below the first threshold when a first modulation and coding scheme (MCS) for the PCC is less than a first MCS level.

Aspect 15: The apparatus of Aspect 13 or 14, in which the first grant is below the first threshold when the PCC is configured for carrying only physical downlink shared channel (PDSCH) traffic.

Aspect 16: The apparatus of any of the Aspects 13-15, in which the at least one processor is further configured: to determine whether a second grant for a secondary component carrier (SCC) is below a second threshold; and to switch the transceiver from the high performance mode to the low power mode in response to the first grant being below the first threshold and the second grant being below the second threshold.

Aspect 17: The apparatus of any of the Aspects 13-16, in which the first grant is below the first threshold when a first modulation and coding scheme (MCS) for the PCC is less than a first MCS level, and the second grant is below the second threshold when a second MCS for the SCC is less than a second MCS level.

Aspect 18: The apparatus of any of the Aspects 13-17, in which the first grant is below the first threshold when a first modulation and coding scheme (MCS) for the PCC is less than a first MCS level, and a second signal to noise ratio (SNR) is above the second threshold when the SCC is configured for carrying only physical downlink control channel (PDCCH) traffic.

Aspect 19: The apparatus of any of the Aspects 13-18, in which the first grant is below the first threshold when the PCC is configured for carrying only physical downlink shared channel (PDSCH) traffic, and the second grant is below the second threshold when the SCC is configured for carrying only PDSCH traffic.

Aspect 20: The apparatus of any of the Aspects 13-19, in which the at least one processor is further configured to switch the wireless RF transceiver from the high performance mode to the low power mode in response to: a PCC signal to noise ratio (SNR) with a low power mode (LPM) synthesizer exceeding an SNR threshold for physical downlink control channel (PDCCH) decoding on the PCC, an SCC SNR with the LPM synthesizer exceeding the SNR threshold for PDCCH decoding on the SCC, receiver reciprocal mixing noise impacting the PCC and impacting the SCC by less than a receiver threshold, transmitter reciprocal mixing noise impacting the PCC and impacting the SCC by less than a transmitter threshold, a jamming signal not being detected, a PCC received signal strength indicator (RSSI) exceeding a reference sensitivity by a predetermined quantity, and an SCC RSSI exceeding the reference sensitivity by the predetermined quantity.

The accompanying claims and their equivalents are intended to cover such forms or modifications as would fall within the scope and spirit of the protection. For example, the example apparatuses, methods, and systems disclosed herein may be applied to multi-SIM wireless devices subscribing to multiple communication networks and/or communication technologies. The various components illustrated in the figures may be implemented as, for example, but not limited to, software and/or firmware on a processor, ASIC/FPGA/DSP, or dedicated hardware. Also, the features and attributes of the specific example aspects disclosed above may be combined in different ways to form additional aspects, all of which fall within the scope of the present disclosure.

The foregoing method descriptions and the process flow diagrams are provided merely as illustrative examples and are not intended to require or imply that the operations of the method must be performed in the order presented. Certain of the operations may be performed in various orders. Words such as “thereafter,” “then,” “next,” etc., are not intended to limit the order of the operations; these words are simply used to guide the reader through the description of the methods.

The various illustrative logical blocks, modules, circuits, and operations described in connection with the aspects disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The hardware used to implement the various illustrative logics, logical blocks, modules, and circuits described in connection with the various aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in processor-executable instructions that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include random access memory (RAM), read-only memory (ROM), electrically erasable programmable read-only memory (EEPROM), FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

Although the present disclosure provides certain example aspects and applications, other aspects that are apparent to those of ordinary skill in the art, including aspects which do not provide all of the features and advantages set forth herein, are also within the scope of this disclosure. Accordingly, the scope of the present disclosure is intended to be defined only by reference to the appended claims.

What is claimed is:

1. A method of controlling a wireless radio frequency (RF) transceiver, comprising:
determining whether a first grant for a primary component carrier (PCC) is below a first threshold and a secondary component carrier (SCC) is deactivated;
switching the wireless RF transceiver from a high performance mode to a low power mode in response to the first grant being below the first threshold; and
processing an incoming signal in an offset zero intermediate frequency (OZIF) mode of the wireless RF transceiver in accordance with the low power mode.

2. The method of claim 1, in which the first grant is below the first threshold when a first modulation and coding scheme (MCS) for the PCC is less than a first MCS level.

3. The method of claim 1, in which the first grant is below the first threshold when the PCC is configured for carrying only physical downlink shared channel (PDSCH) traffic.

4. The method of claim 1 further comprising switching the wireless RF transceiver from the high performance mode to the low power mode in response to: a signal to noise ratio (SNR) with a low power mode (LPM) synthesizer exceeding an SNR threshold for physical downlink control channel (PDCCH) decoding on the PCC, receiver reciprocal mixing noise impacting the PCC by less than a receiver threshold, transmitter reciprocal mixing noise impacting the PCC by less than a transmitter threshold, a jamming signal not being detected, and a PCC received signal strength indicator (RSSI) exceeding a reference sensitivity by a predetermined quantity.

5. The method of claim 1, in which the wireless RF transceiver processes the incoming signal with a low power mode synthesizer in accordance with the low power mode.

6. The method of claim 1, in which a first signal to noise ratio (SNR) is above a first SNR threshold when the PCC is configured for carrying physical downlink control channel (PDCCH) only traffic.

7. The method of claim 1, further comprising:
determining whether a second grant for the SCC is below a second threshold; and
switching the transceiver from the high performance mode to the low power mode in response to the first grant being below the first threshold and the second grant being below the second threshold.

8. The method of claim 7, in which the first grant is below the first threshold when a first modulation and coding scheme (MCS) for the PCC is less than a first MCS level, and the second grant is below the second threshold when a second MCS for the SCC is less than a second MCS level.

9. The method of claim 7, in which the first grant is below the first threshold when a first modulation and coding scheme (MCS) for the PCC is less than a first MCS level, and a second signal to noise ratio (SNR) is above the second threshold when the SCC is configured for carrying only physical downlink control channel (PDCCH) traffic.

10. The method of claim 7, in which the first grant is below the first threshold when the PCC is configured for carrying only physical downlink shared channel (PDSCH) traffic, and the second grant is below the second threshold when the SCC is configured for carrying only PDSCH traffic.

11. The method of claim 7, in which a first signal to noise ratio (SNR) is above a first SNR threshold when the PCC is configured for carrying only physical downlink control channel (PDCCH) traffic, and a second SNR is above a second SNR threshold when the SCC is configured for carrying only PDCCH traffic.

12. The method of claim 7 further comprising switching the wireless RF transceiver from the high performance mode to the low power mode in response to: a PCC signal to noise ratio (SNR) with a low power mode (LPM) synthesizer exceeding an SNR threshold for physical downlink control channel (PDCCH) decoding on the PCC, an SCC SNR with the LPM synthesizer exceeding the SNR threshold for PDCCH decoding on the SCC, receiver reciprocal mixing noise impacting the PCC and impacting the SCC by less than a receiver threshold, transmitter reciprocal mixing noise impacting the PCC and impacting the SCC by less than a transmitter threshold, a jamming signal not being detected, a PCC received signal strength indicator (RSSI) exceeding a reference sensitivity by a predetermined quantity, and an SCC RSSI exceeding the reference sensitivity by the predetermined quantity.

13. An apparatus for controlling a wireless radio frequency (RF) transceiver, comprising:
at least one memory; and
at least one processor coupled to the at least one memory, the at least one processor configured:
to determine whether a first grant for a primary component carrier (PCC) is below a first threshold and a secondary carrier component (SCC) is deactivated;
to switch the wireless RF transceiver from a high performance mode to a low power mode in response to the first grant being below the first threshold; and
to process an incoming signal in an offset zero intermediate frequency (OZIF) mode of the wireless RF transceiver in accordance with the low power mode.

14. The apparatus of claim 13, in which the first grant is below the first threshold when a first modulation and coding scheme (MCS) for the PCC is less than a first MCS level.

15. The apparatus of claim 13, in which the first grant is below the first threshold when the PCC is configured for carrying only physical downlink shared channel (PDSCH) traffic.

16. The apparatus of claim 13, in which the at least one processor is further configured:
to determine whether a second grant for the SCC is below a second threshold; and
to switch the transceiver from the high performance mode to the low power mode in response to the first grant being below the first threshold and the second grant being below the second threshold.

17. The apparatus of claim 16, in which the first grant is below the first threshold when a first modulation and coding scheme (MCS) for the PCC is less than a first MCS level, and the second grant is below the second threshold when a second MCS for the SCC is less than a second MCS level.

18. The apparatus of claim 16, in which the first grant is below the first threshold when a first modulation and coding scheme (MCS) for the PCC is less than a first MCS level, and a second signal to noise ratio (SNR) is above the second threshold when the SCC is configured for carrying only physical downlink control channel (PDCCH) traffic.

19. The apparatus of claim 16, in which the first grant is below the first threshold when the PCC is configured for carrying only physical downlink shared channel (PDSCH) traffic, and the second grant is below the second threshold when the SCC is configured for carrying only PDSCH traffic.

20. The apparatus of claim 16, in which the at least one processor is further configured to switch the wireless RF transceiver from the high performance mode to the low power mode in response to: a PCC signal to noise ratio (SNR) with a low power mode (LPM) synthesizer exceeding an SNR threshold for physical downlink control channel (PDCCH) decoding on the PCC, an SCC SNR with the LPM synthesizer exceeding the SNR threshold for PDCCH decoding on the SCC, receiver reciprocal mixing noise impacting the PCC and impacting the SCC by less than a receiver threshold, transmitter reciprocal mixing noise impacting the PCC and impacting the SCC by less than a transmitter threshold, a jamming signal not being detected, a PCC received signal strength indicator (RSSI) exceeding a reference sensitivity by a predetermined quantity, and an SCC RSSI exceeding the reference sensitivity by the predetermined quantity.
